(19) United States
(12) Patent Application Publication
(10) Pub. No.: US 2024/0216109 A1
(43) Pub. Date: Jul. 4, 2024

(54) DENTAL DEVICE AND METHOD OF USE

(71) Applicant: Russell J. Crockett, Casa Grande, AZ (US)

(72) Inventor: Russell J. Crockett, Casa Grande, AZ (US)

(21) Appl. No.: 18/554,171

(22) PCT Filed: Apr. 5, 2022
(86) PCT No.: PCT/US22/23519

§ 371 Date: Oct. 5, 2023

Related U.S. Application Data
(60) Provisional application No. 63/171,437, filed on Apr. 6, 2021.

(51) Int. Cl. A61C 7/14; A61C 8/00

(52) U.S. Cl. CPC A61C 7/146; A61C 8/0048

(57) ABSTRACT

A dental device having one or more fastening components each having a longitudinal axis and a wing region that extends radially outwardly from the longitudinal axis. The longitudinal axis of the fastening component is configured to mate with a dental attachment in a dental arch. The wing region has a top surface, a bottom surface, side surfaces, and a vertical structure protruding from the top surface. The wing region also has one or more attachment areas configured to couple with one another and/or a frame member. The frame member has a top surface, a bottom surface, and one or more attachment area configured to couple with the wing regions of the fastening components.

This application claims the benefit of priority to U.S. Provisional Patent Application No. 63/171,437 filed on Apr. 6, 2021, which is incorporated herein by reference in its entirety.

### FIELD OF THE INVENTION

The field of the invention is dental devices, in particular, dental implant verification jigs for verifying the accuracy of a dental model that relates the exact physical position, rotation and angulation of one or more dental attachments in the dental arch.

### BACKGROUND

The background description includes information that may be useful in understanding the present invention. It is not an admission that any of the information provided herein is prior art or relevant to the presently claimed invention, or that any publication specifically or implicitly referenced is prior art.

Dental technicians use digital or casted physical models to design and fabricate custom prosthetics that replace missing or removed teeth in a patient's jaw. When dental implants are involved, highly accurate records are critical to ensure precisely fitting prosthetics on the corresponding components of both the model as it is being made, and the patient it is meant for. Dental implant verification jigs are used to verify accurate records when prosthetics are designed to fit multiple dental implants in the same jaw. Verification jigs are critical when multiple implants are involved because even the tiniest error between the patient and the model can result in ill-fitting prosthetics. Currently, traditional methods of casting dental models or intraoral scanning of digital models is not accurate enough to fabricate precisely fitting custom prosthetics made for multiple implants on the same jaw.

Casted dental models are made by attaching implant impression copings or temporary prefabricated copings to the dental implants or dental implant abutments in the patient's jaw. A negative imprint of the patient's jaw with the copings is taken using dental impression materials. Subsequently, a positive reproduction of the patient's jaw in the form of a cast or model is made from the negative imprint that includes dental implant replicas or analogs to represent the dental implants in the patient's jaw. While these models are good enough to manufacture most dental prosthetics that don't require high precision, inherent material dimensional fluctuations and inconsistent operator methods for fabricating these casted models make them not accurate enough for fabricating prosthetics for multiple implants on the same jaw.

Digital models for computer aided design of dental prosthetics are typically three-dimensionally scanned copies of the casted dental model. Dental labs use highly precise three-dimensional benchtop scanners manufactured specifically for the dental field to create these digital models. But these scans are only as accurate as the casted dental model they are scanning. More recently, intraoral scanners (e.g., 3Shape Trios, iTero, Medit, Dentsply PrimeScan) are able to capture a three-dimensional digital model directly from the patient's mouth. However, the intraoral scanning technology that currently exists has inherent limitations that prevent it from being accurate enough for fabricating prosthetics for multiple implants on the same jaw.

Dental implant verification jigs are therefore used to verify the accuracy of digital or casted dental models that relate the exact position, rotation and angulation of dental implants placed in a patient's jaw. They also capture the exact relative three-dimensional relationship between each implant and each of the other implants in three-dimensional space. Extremely high precision is required for these jigs so that the accuracy of the casted models or digital models can be verified. Only then can a dental technician confidently design and manufacture prosthetics to precisely fit the implants that were placed in the patient's jaw.

Dental implant verification jigs are custom made by dental technicians by attaching impression copings or temporary prefabricated copings to the dental implant replicas or analogs on the casted model reproduction of the patient's jaw. Dental floss is often used to create a scaffolding between adjacent copings to hold the adhesive acrylic resin material that is applied and cured around each of the copings and between adjacent copings. Once cured, the copings will be rigidly attached to each other and can be removed in one piece.

The resin material that is used to make these custom jigs has a propensity to shrink as it cures and will often create some inaccuracies. The more resin that is used between the copings, the more the copings will fluctuate dimensionally from the relative three-dimensional positions they are meant to capture as it cures. In order to minimize the effect of this shrinkage, a dental lab or clinician will first attach all of the impression copings together with resin material between the implant analogs on the model to make a model jig that represents the implant positions on the casted model. Once that resin fully cures with UV light or time in ambient light, they will cut the jig into sections to release tension from acrylic shrinkage and isolate each coping from the others. A small gap between the acrylic resin of the two cut pieces of the jig is left. This “sectioned” jig is used to verify the implant positions directly in the patient's mouth. The clinician will then fasten each section of the jig to the corresponding dental implant in the patient's jaw and reconnect the jig with a minimal amount of acrylic resin in the small gaps between the sections. With a minimal amount of acrylic resin between the sections to cure, any shrinkage that does occur will be insignificant. It can be assumed that the now “verified” jig is the most accurate physical reproduction of the relative three-dimensional positions of the dental implants in the patient's jaw. This verification jig fabricated in the patient's mouth will be used to verify the accuracy of the physical and digital models. Once these models are verified, a permanent prosthesis can be manufactured with confidence that it will fit the patient's dental implants precisely.

Since these verification jigs are custom made and require labor to produce them, there remains a need for a low cost mass-produced dental device that is versatile enough to universally adapt to a number of variables that only custom made appliances have thus far been able to achieve. These variables include, but are not limited to, the number of dental implants that will be placed, the size of the mouth that is being treated, and the unique connections of the dental implant components. If a single mass-produced dental device can universally adapt to a majority of these variables, it would significantly simplify the fabrication of custom prosthetics with multiple implants on the same jaw. It would also reduce costs by eliminating the need to create custom verification jigs that would often require hours of combined work for the clinician, the patient and the dental technician.

Additionally, there is a significant need to simplify the various steps of dental implant fixed and removable full arch rehabilitation procedures. As one of the most complex procedures in dentistry, each eliminated step significantly decreases the overall complexity of the procedure. Removing the need for custom made verification jigs would also save time, reduce costs, and allow for more clinicians to treat more patients.

There also remains a need to ensure that a minimal amount of resin is used when splinting dental implants together to make a jig. As all resins are subject to shrinkage, minimizing the distance between connecting parts will also minimize the effect of shrinkage. Overlapping components or components designed to nest with adjacent components can significantly mitigate the error created by resin shrinkage.

Finally, when using adhesive or hardening materials to lute or bond components together in the mouth, there is always risk of accidentally spilling some excess material into the screw hole of a fastening component or implant component. This could be a catastrophic complication as the hardened material may permanently block the clinician's ability to access the screw and remove the components from the mouth. When this happens, the clinician may have to surgically extract the dental implant from the mouth. This type of procedure will often cause the patient significant trauma. Therefore, additional safety features are necessary to prevent catastrophic complications like this from happening. Devices designed to be luted in the mouth on top of implants would benefit from safety mechanisms that shield or block luting material from entering the screw hole and covering the screw that fastens dental implant components to the dental implant.

Thus, there remains a need for improved dental devices and their methods of use.

### SUMMARY OF THE INVENTION

The inventive subject matter provides apparatus, systems, and methods in which a dental device comprises one or more fastening components with a wing region and a frame member. Each fastening component has a top surface, a bottom surface, and an opening passing from the top surface to the bottom surface. The opening is sized and dimensioned to receive various dental attachments on a jaw, such as a dental implant or an abutment and fastened with a screw. Since each manufacturer makes their own versions of dental implants or abutments, the opening of the fastening component can be sized and dimensioned to adapt to the various dimensions of each manufacturer. The wing region also has a top surface, and a bottom surface. The top and bottom surface of the wing region comprises one or more attachment areas configured to couple with the frame member. The wing region also has a vertical structure that protrudes from the top surface of the wing region. This vertical structure has a front surface facing the end of the wing, side surfaces parallel to the wing and a back surface facing the opening of the fastening component. The front and side surfaces of the vertical structure are configured to couple with the attachment area of the frame member.

The frame member has an edge around the frame, a top surface, and a bottom surface. The edge, the top surface and/or the bottom surface of the frame member comprises one or more attachment areas configured to couple with an attachment area of the wing region of the fastening component. The frame member can be coupled with the fastening component using a luting or bonding material. The vertical structure of the wing region of the fastening component is also designed to prevent luting or bonding material from entering the opening of the fastening component and covering the screw, which would be very difficult to remedy once dried and could cause a dangerous complication for the patient. With this in mind, a fastening component can be affixed to each dental attachment placed in an edentulous jaw. When done correctly, the fastening components will be bonded together with the frame member to create the previously described verification jig.

In some embodiments the attachment areas on the top and bottom surface of the frame member and top surface of the wing regions can comprise a plurality of protrusions to help retain the luting or bonding material and improve the luting/bonding strength. The protrusions can be tapered or frustoconical shaped to improve retention of the luting or bonding material. The attachment areas of both the wing region and the frame member can also have undercuts or texture that helps to retain the luting or bonding material. Additionally, the frame member may be manufactured as a flat lattice of any geometrically shaped holes through the frame member from the top to the bottom. This lattice design provides ample three-dimensional structures for the luting material to bond the frame member to the fastening components. Finally, it is also contemplated that the attachment areas could be flat surfaces, or surfaces that have mating features (e.g., similar contours, nesting shapes).

In some embodiments, the fastening components are sized and dimensioned to rotatably couple with the dental attachments in the mouth to allow for adjustment of the orientation of the fastening component and its wing region (e.g., positioning the fastening component so that the wing region extends palatally in the jaw and as close as possible to other fastening components). The fastening component can be made in different sizes that fit different sizes or types of existing dental attachments.

From a methods perspective, the inventive subject matter provides a method of using the dental device by coupling the fastening components to several dental attachments in a patient's jaw with a screw. The fastening components are then rotated about the attachment in order to position the wing regions of each fastener component close together. Finally, the wing region of the fastening components are luted or bonded together with a frame member using commonly available dental acrylic or composite materials. The method further includes the step of removing the entire apparatus of several fastening components luted together with the frame member and using it to verify the accuracy of dental models that relate the exact physical position, rotation and angulation of dental implant or abutment attachments placed in a patient's jaw. It is also contemplated that a plurality of frame members and fastening components can be chosen from a variety of sizes and applications that may be necessary to account for different anatomies among human jaws.

The inventive subject matter also provides a method of using the vertical structure protruding from the top of the wing region of the fastening component to shield or block the luting or bonding material from entering the opening of the fastening component and covering the screw hole.

The inventive subject matter also provides apparatus, systems, and methods in which a dental device comprises a plurality of fastening components, each one having a wing region. Each fastening component can be attached to a dental attachment in a dental arch and arranged such that their wing regions are nested in close proximity to an adjacent wing region. The wing regions can be joined together with an adhesive or a luting material such that all the plurality of fastening components are joined together to form a single apparatus. The single apparatus can be removed from the dental attachments and used as a verification jig. Prior to removal, the fastening components can be scanned.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a perspective view of a dental device affixed to a dental arch.

FIG. 2 is a front view of the dental device and dental arch in FIG. 1.

FIG. 3 is an exploded perspective view of the dental device and dental arch in FIG. 1.

FIG. 4 is an exploded front view of the dental device in FIG. 3.

FIG. 5 is a partially exploded perspective view of the dental device in FIG. 1 with the fastening components attached to the implants.

FIG. 6 is a partially exploded front view of the dental device in FIG. 5.

FIG. 7a is a side view of the fastening component in FIG. 1.

FIG. 7b is a perspective view of the fastening component in FIG. 1.

FIG. 7c is a plan view of the fastening component in FIG. 1.

FIG. 8a is a front view of the frame member in FIG. 1.

FIG. 8b is a perspective view of the frame member in FIG. 1.

FIG. 8c is a plan view of the frame member in FIG. 1.

FIG. 9 is an exploded side view of the implant, abutment, and fastening component in FIG. 1.

FIG. 10 is an exploded side view of an implant and another embodiment of a fastening component.

FIG. 11 is a side view of the implant, abutment, and the fastening component of either FIG. 9 or FIG. 10.

FIG. 12 is an exploded perspective view of another embodiment of a dental device and dental arch.

FIG. 13 is an exploded front view of the dental device and dental arch in FIG. 12.

FIG. 14 is an exploded side view of the dental device and dental arch in FIG. 12.

FIG. 15 is a plan view of another embodiment of a dental device comprising a plurality of fastening components.

FIG. 16 is a plan view of the dental device of FIG. 15 with the fastening components jointed together by and adhesive or luting material to form a single apparatus.

FIG. 17 is a perspective view of the dental device of FIG. 16.

FIG. 18 is a front view of the dental device of FIG. 16.

FIG. 19 is a perspective view of another embodiment of a dental device affixed to a dental arch.

FIG. 20 is a front view of the dental device and dental arch in FIG. 19.

FIG. 21 is an exploded perspective view of the dental device and dental arch in FIG. 19.

FIG. 22 is an exploded front view of the dental device in FIG. 21.

FIG. 23 is a partially exploded perspective view of the dental device in FIG. 19 with the fastening components attached to the implants.

FIG. 24 is a partially exploded front view of the dental device in FIG. 23.

FIG. 25a is a side view of the fastening component in FIG. 19.

FIG. 25b is a perspective view of the fastening component in FIG. 19.

FIG. 25c is a plan view of the fastening component in FIG. 19.

FIG. 26a is a front view of the frame member in FIG. 19.

FIG. 26b is a perspective view of the frame member in FIG. 19.

FIG. 26c is a plan view of the frame member in FIG. 19.

FIG. 27 is an exploded side view of the implant, abutment, and fastening component in FIG. 19.

FIG. 28 is an exploded side view of an implant and another embodiment of a fastening component.

FIG. 29 is a side view of the implant, abutment, and the fastening component of either FIG. 27 or FIG. 28.

FIG. 30 is an exploded perspective view of another embodiment of a dental device and dental arch.

FIG. 31 is an exploded front view of the dental device and dental arch in FIG. 30.

FIG. 32 is an exploded side view of the dental device and dental arch in FIG. 30.

FIG. 33 is a plan view of another embodiment of a dental device comprising a plurality of fastening components.

FIG. 34 is a plan view of the dental device of FIG. 33 with the fastening components jointed together by and adhesive or luting material to form a single apparatus.

FIG. 35 is a perspective view of the dental device of FIG. 34.

FIG. 36 is a front view of the dental device of FIG. 34.

### DETAILED DESCRIPTION OF THE INVENTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

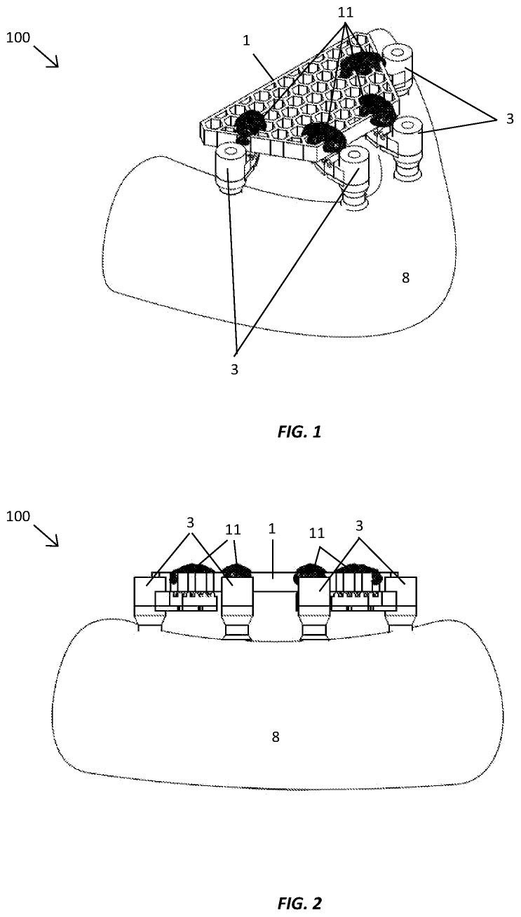

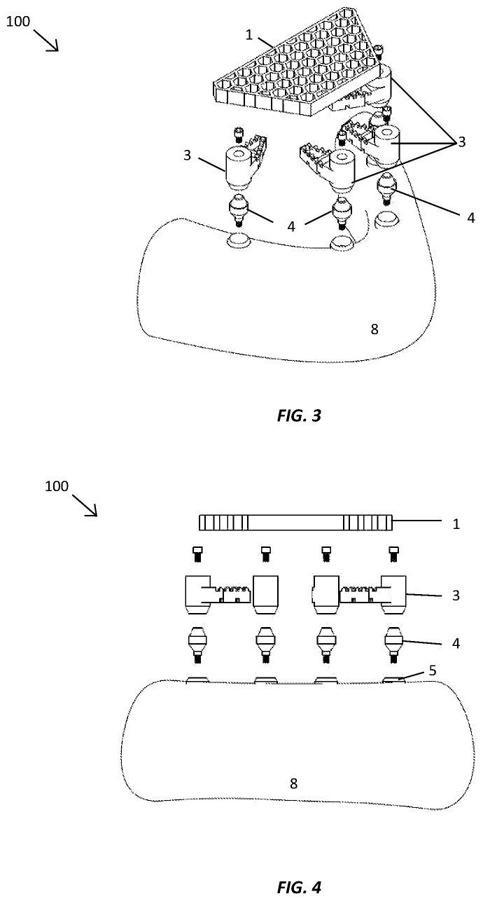

FIG. 1 shows a perspective view of a dental device 100 assembled on a dental arch 8. FIG. 2 shows a front view of dental device 100 and dental arch 8. FIG. 3 shows a perspective exploded view of dental device 100. FIG. 4 shows a front exploded view of dental device 100. Dental device 100 comprises a frame member 1 coupled with fastening components 3, which are attached to four abutments 4, which are attached to four implants 5 in dental arch 8. Fastening components 3 can be affixed to abutments 4 using a screw or any other known fastener. Dental arch 8 can comprise a maxillary jaw arch or mandibular jaw arch of any person of any age and/or size. The dental arch could also comprise an artificial physical model of a person's maxillary or mandibular arch. The model can be made of various gypsum materials or resin materials.

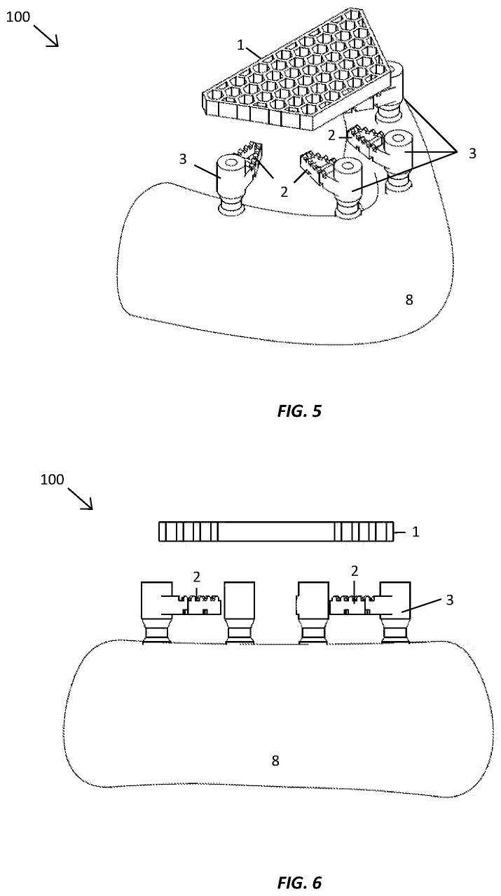

FIG. 5 shows a perspective partially exploded view of dental device 100 with fastening components 3 affixed to abutments 4. FIG. 6 shows a front partially exploded view of dental device 100 with fastening components 3 affixed to abutments 4. Fastening components 3 have wing regions 2 that affix to frame member 1. Fastening components 3 can be rotated to adjust the placement and orientation of their wing regions 2. The length of wing regions 2 extend into a center region of dental arch 8 to provide a platform for attaching frame member 1. The wing regions 2 can be placed on the central implants first and lateral implants afterward to ensure that there is plenty of space for all the wing regions 2. The wing members should converge and create a relatively even and stable platform for the frame member.

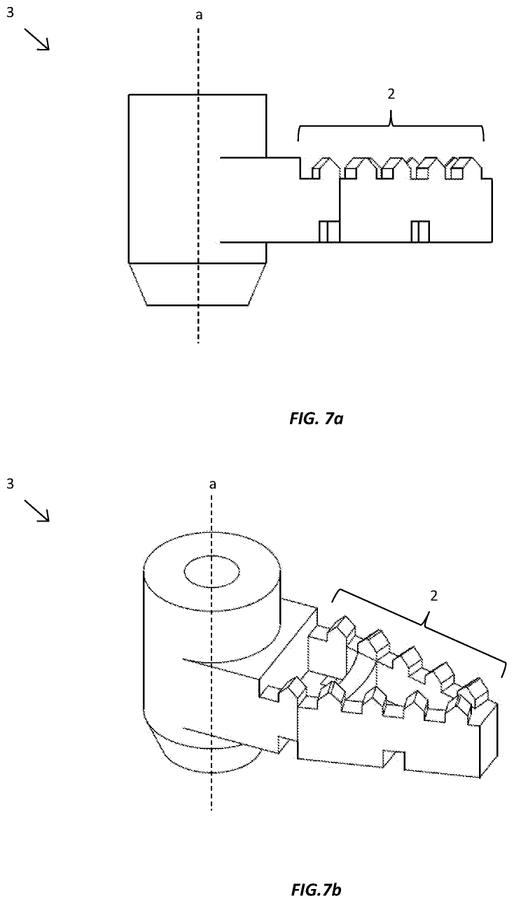

FIG. 7a shows a side view of fastening component 3. Fastening component 3 has a cylindrical body with a through-hole having a longitudinal axis “a.” Fastening component 3 also has a wing region 2 extending radially outward from the cylindrical body with a tapered end and teeth protrusions on their top surface. FIG. 7b shows a perspective view of fastening component 3. FIG. 7c shows a plan view of fastening component 3.

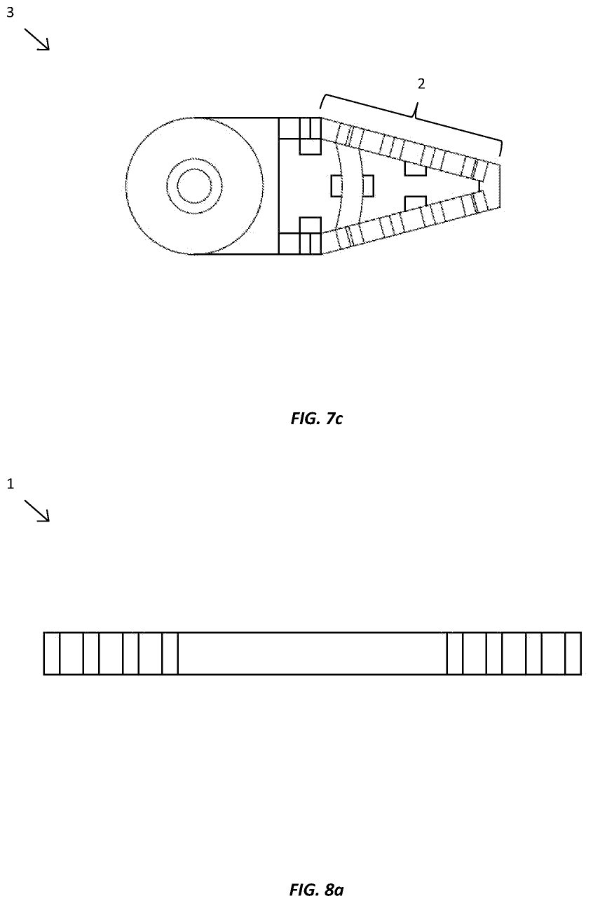

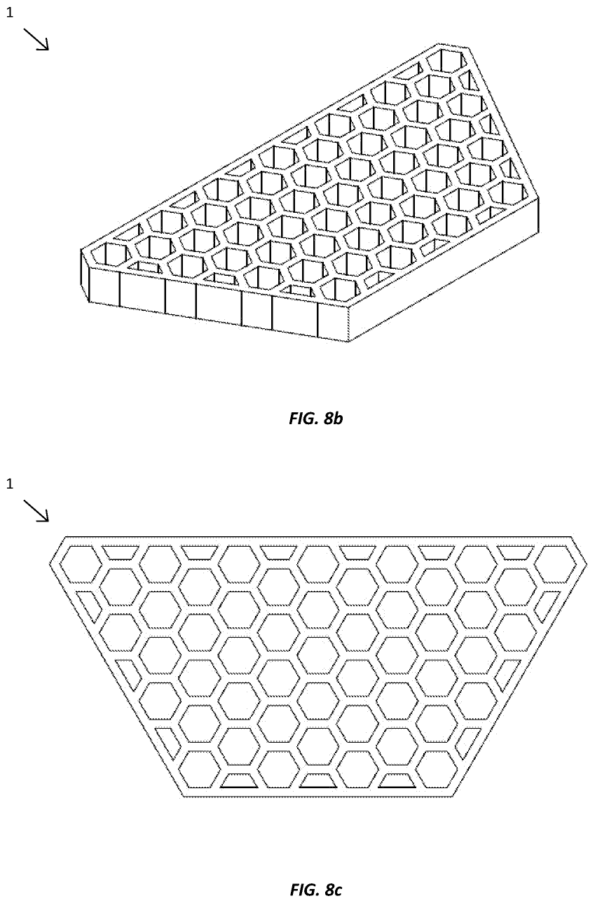

FIG. 8a shows a front view of frame member 1. FIG. 8b shows a perspective view of frame member 1. Figure Sc shows a plan view of frame member 1. Frame member 1 has a trapezoidal shape. However, other shapes are possible, including half-circles, triangles, squares, rectangles, and irregular non-geometric shapes. Frame member 1 is sized and dimensioned to fit in dental arch 8. Frame member 1 can be scored (e.g., measured, sized) in a way that would make it easy to size the frame to fit the dental arch. For example, the frame member 1 can be scored to show its general size for overall length and overall width. The length and width of the frame member 1 should fit within the arch of the patient and span across all of the wing regions 2 as equally as possible. Frame member 1 should also have a space between it and the longitudinal axis cylindrical body of the fastening components 3 for accurate scanning. Frame member 1 can be made of resin, PMMA (Polymethlymethacrylate), PEEK (Polyether ether ketone), stainless steel, chrome cobalt or titanium, including radiopaque materials for visibility in x-ray imaging and non-polished surfaces for better visibility in intraoral scanning.

Once fastening components 3 are positioned in place at the implant sites, frame member 1 is placed on and coupled with the wing regions 2. Frame member 1 can be coupled to wing regions 2 with a luting material or a bonding material. Frame member 1 has a plurality of openings and wing regions 2 have a plurality of teeth to improve the mechanical bond with the luting or bonding material. Contemplated luting materials include dental luting cements or any material that sticks to a surface and hardens. Contemplated bonding materials include self-cure acrylic resin, bis-acryl composite resins, dual cure acrylics, chemical adhesives and dental cements. The luting or bonding material is placed on the wing regions 2 and or frame member 1 before placing and holding frame member 1 onto wing regions 2.

It is also contemplated that frame member 1 and/or wing regions 2 could have undercuts or textures to help hold luting and/or bonding material and to improve the strength of the bond. In yet other embodiments, it is contemplated that the attachment areas of both the wing members 2 and frame member 1 can be flat, or can have similar shaped/contoured areas that mate or nest with one another to improve mechanical engagement of the frame member 1 with wing members 2. The luting or bonding material can be selected based on the composition of the wing region 2 and frame member 1 as well as the configuration of the attachment areas (e.g., flat surface, protrusions, etc.).

FIG. 9 shows a side exploded view of the fastening component 3, abutment 4, and implant 5.

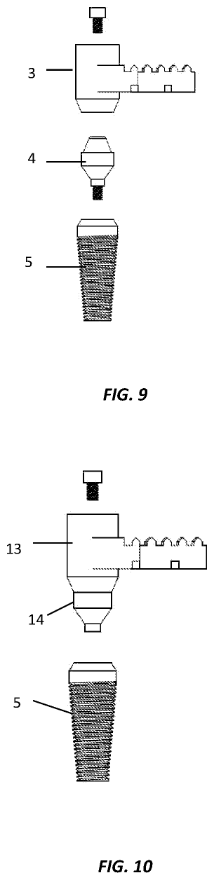

FIG. 10 shows a fastening component 13, which is similar to fastening component 3 except that it has as an abutment region 14. Abutment region 14 has tapered surfaces that are sized and dimensioned to mate with the opening in implant 5, thus eliminating the need for an abutment 4.

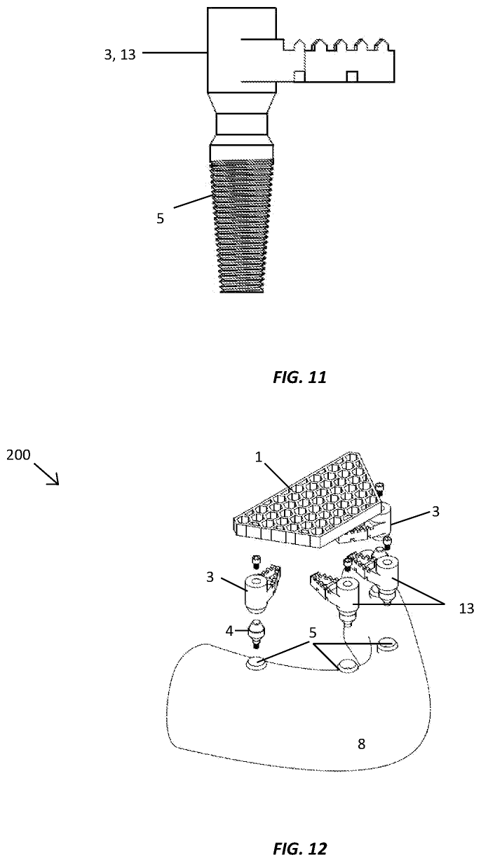

FIG. 11 shows a side view of either fastening component 3 or 13 fastened to implant 5.

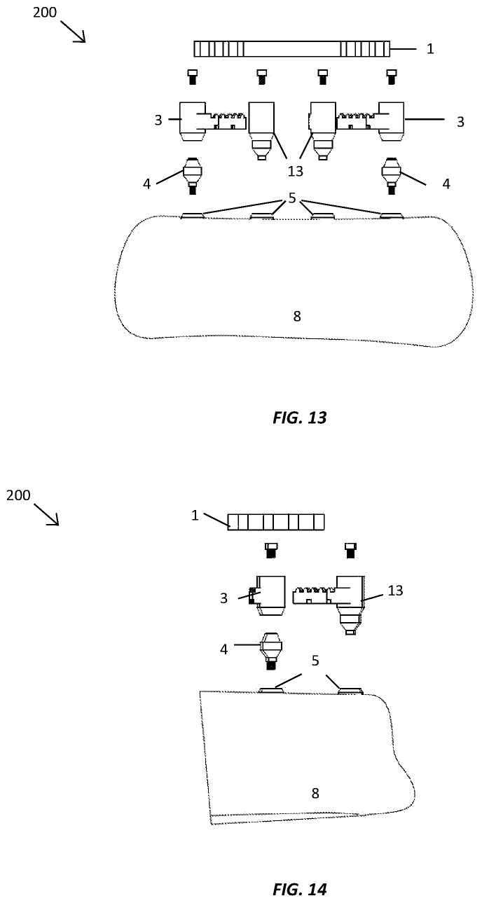

FIG. 12 shows a perspective exploded view of a dental device 200 and dental arch 8. Dental device 200 is similar to dental device 100 except that the two central fastening components 3 have been replaced with fastening components 13. FIG. 13 shows a front exploded view of dental device 200 and dental arch 8. FIG. 14 shows a side exploded view of dental device 200 and dental arch 8.

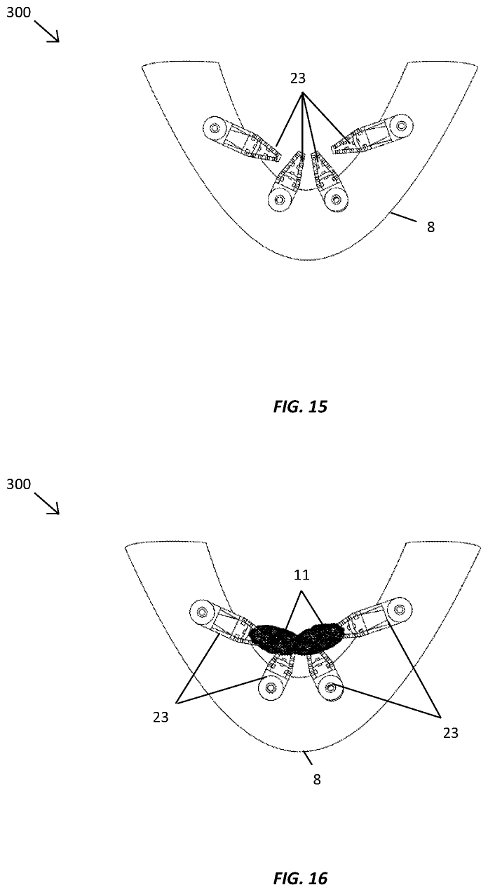

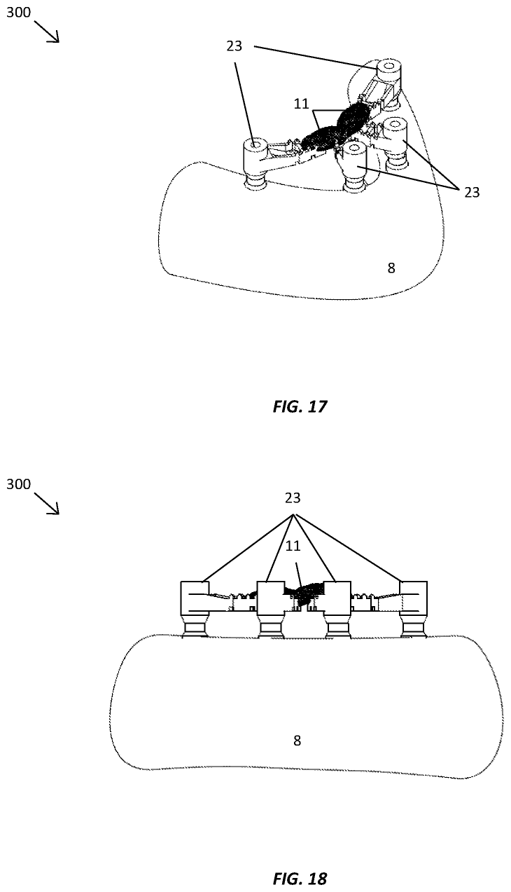

FIG. 15 shows a dental device 300 on dental arch 8. Dental device 300 comprises a plurality of fastening components 23. Fastening components 23 are similar to fastening components 3 except that they have longer wing regions. Each wing region is positioned to be in close proximity with adjacent wing regions. Once they are positioned in close proximity with adjacent wing regions, the wing regions are joined together using an adhesive or luting material 11 as shown in FIGS. 16-18. Once joined together, fastening components 23 can be scanned with an intraoral camera to record their location, orientation, and angulation. Fastening components 23 can also be removed as a single unit and used as a verification jig. Dental device 300 is different than dental device 100 and 200 in that no frame member 1 is required.

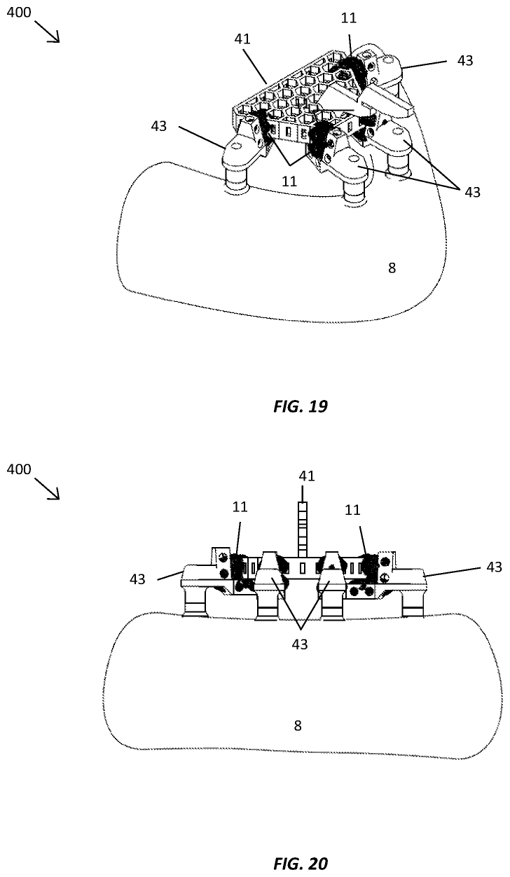

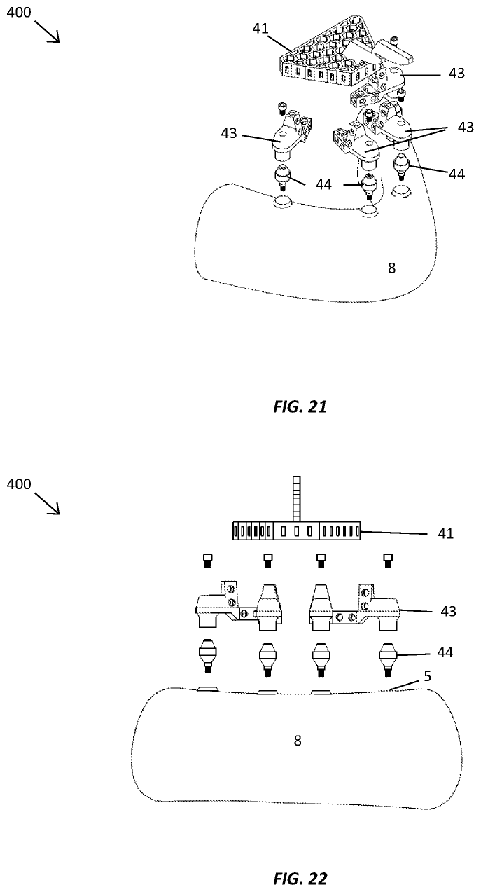

FIG. 19 shows a perspective view of a dental device 400 assembled on a dental arch 8. FIG. 20 shows a front view of dental device 400 and dental arch 8. FIG. 21 shows a perspective exploded view of dental device 400. FIG. 22 shows a front exploded view of dental device 400. Dental device 100 comprises a frame member 41 coupled with fastening components 43, which are attached to four abutments 44, which are attached to four implants 5 in dental arch 8. Fastening components 43 can be affixed to abutments 44 using a screw or any other known fastener. Dental arch 8 can comprise a maxillary jaw arch or mandibular jaw arch of any person of any age and/or size. The dental arch could also comprise an artificial physical model of a person's maxillary or mandibular arch. The model can be made of various gypsum materials or resin materials.

The fastening components 43 and the frame member 42 minimize or eliminate dimensional fluctuation after the device is fabricated and throughout the life of its use due to shrinkage of a cured resin. Fastening components 43 and frame member 42 can be made of any non-resin and non-shrinking material, and preferably comprises a dimensionally stable material that remains strong and rigid over time in either dry/wet environments and hot/cold temperatures.

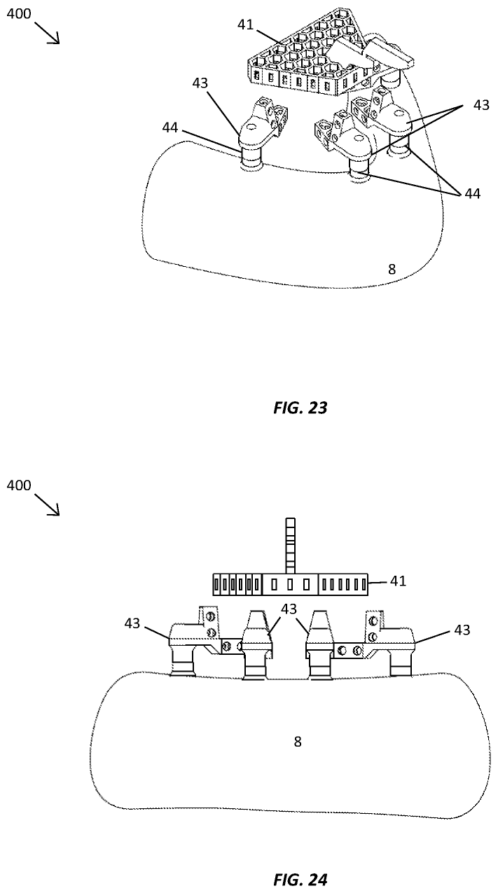

FIG. 23 shows a perspective partially exploded view of dental device 400 with fastening components 43 affixed to abutments 44. FIG. 24 shows a front partially exploded view of dental device 400 with fastening components 43 affixed to abutments 44. Fastening components 43 have wing regions 42 that affix to frame member 41. Fastening components 43 can be rotated to adjust the placement and orientation of their wing regions 42. The length of wing regions 42 extend into a center region of dental arch 8 to provide a platform for attaching frame member 41. The wing regions 42 can be placed on the central implants first and lateral implants afterward to ensure that there is plenty of space for all the wing regions 42. The wing members 42 should converge and create a relatively even and stable platform for the frame member 41.

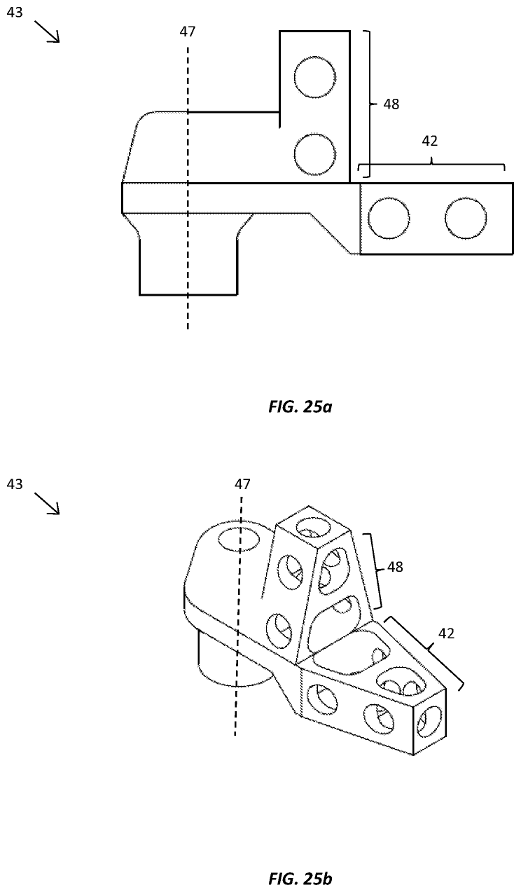

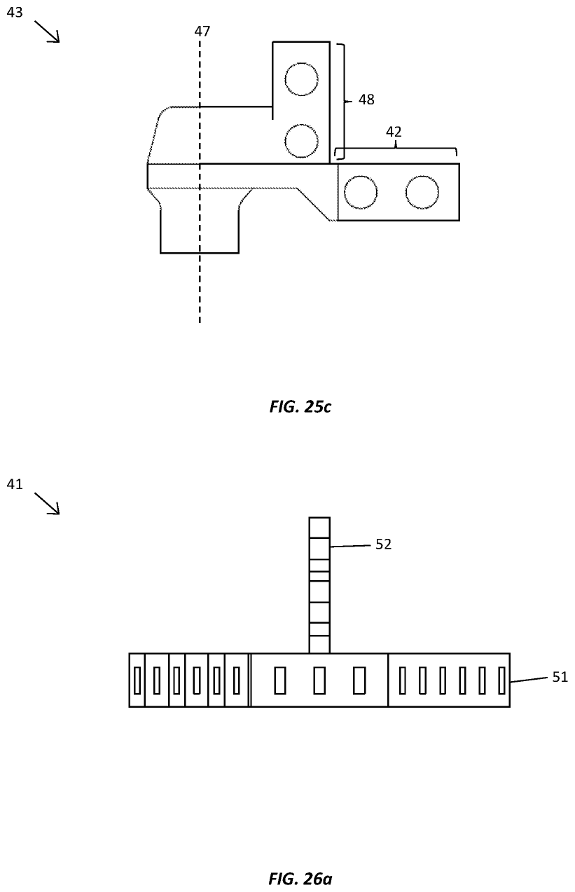

FIG. 25a shows a side view of fastening component 43. Fastening component 43 has a cylindrical body with a through-hole having a longitudinal axis 47. Fastening component 43 also has a wing region 42 extending radially outward from the cylindrical body and long axis 47. Fastening component also has a vertical structure 48 protruding upward from the wing region 42. FIG. 25b shows a perspective view of fastening component 43. Vertical structure 48 has four sides; a front surface facing away from the long axis 47, a back surface facing towards the long axis 47, and two side surfaces extending parallel between the front and back surfaces (e.g., parallel to the length of the wing region 42). The top of vertical structure 48 is higher than the opening of long axis 47 and this helps to shield opening 47 from filling with a hardening material. The wing region 42 provides a flat surface for attaching frame member 41. FIG. 25c shows a plan view of fastening component 43.

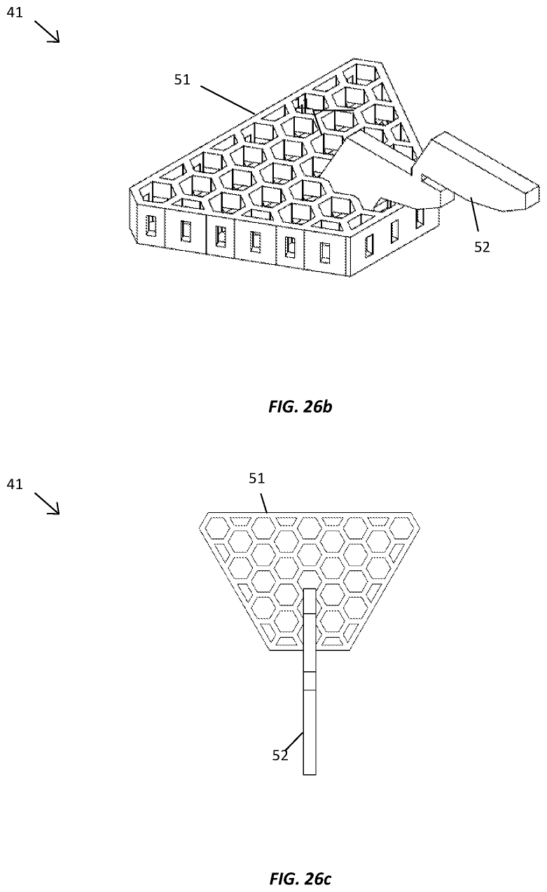

FIG. 26a shows a front view of frame member 41. FIG. 26b shows a perspective view of frame member 41. FIG. 26c shows a plan view of frame member 41. Frame member 41 is similar to frame member 1 in that it has body member 51 with a trapezoidal shape. However, frame member 41 also has a fin 52 extending from the trapezoidal body member 51. Fin 52 is useful as a handle to position the frame member on the wing regions when the dental device is in a patient's mouth.

Frame member 41 is sized and dimensioned to fit in dental arch 8. The size of frame member 41 should fit within the arch of the patient and span across all of the wing regions 42 as equally as possible. Frame member 41 should also have a space between it and the cylindrical body of the fastening components 43 for accurate scanning. Frame member 41 can be made of resin, PMMA (Polymethlymethacrylate), PEEK (Polyether ether ketone), stainless steel, chrome cobalt or titanium, including radiopaque materials for visibility in x-ray imaging and non-polished surfaces for better visibility in intraoral scanning.

Once fastening components 43 are positioned in place at the implant sites, frame member 41 is placed on and coupled with the wing regions 42. Frame member 41 can be coupled to wing regions 42 with a luting material or a bonding material 11. Frame member 41 has a plurality of openings and wing regions 42 have a plurality of openings to improve the mechanical bond with the luting or bonding material 11. Contemplated luting materials include dental luting cements or any material that sticks to a surface and hardens. Contemplated bonding materials include self-cure acrylic resin, bis-acryl composite resins, dual cure acrylics, chemical adhesives and dental cements. The luting or bonding material is placed on the wing regions 42 and or frame member 41 before placing and holding frame member 41 onto wing regions 42.

It is also contemplated that frame member 41 and/or wing regions 42 could have undercuts or textures to help hold luting and/or bonding material and to improve the strength of the bond. In yet other embodiments, it is contemplated that the attachment areas of both the wing members 42 and frame member 41 can be flat, or can have similar shaped/contoured areas that mate or nest with one another to improve mechanical engagement of the frame member 41 with wing members 42. The luting or bonding material 11 can be selected based on the composition of the wing region 42 and frame member 41 as well as the configuration of the attachment areas (e.g., flat surface, protrusions, etc.).

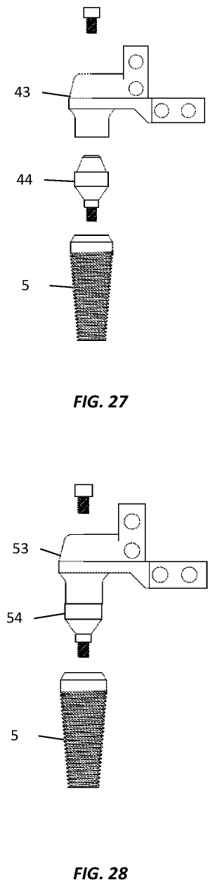

FIG. 27 shows a side exploded view of the fastening component 43, abutment 44, and implant 5.

FIG. 28 shows a fastening component 53, which is similar to fastening component 43 except that it has as an abutment region 54. Abutment region 54 has tapered surfaces that are sized and dimensioned to mate with the opening in implant 5, thus eliminating the need for an abutment 44.

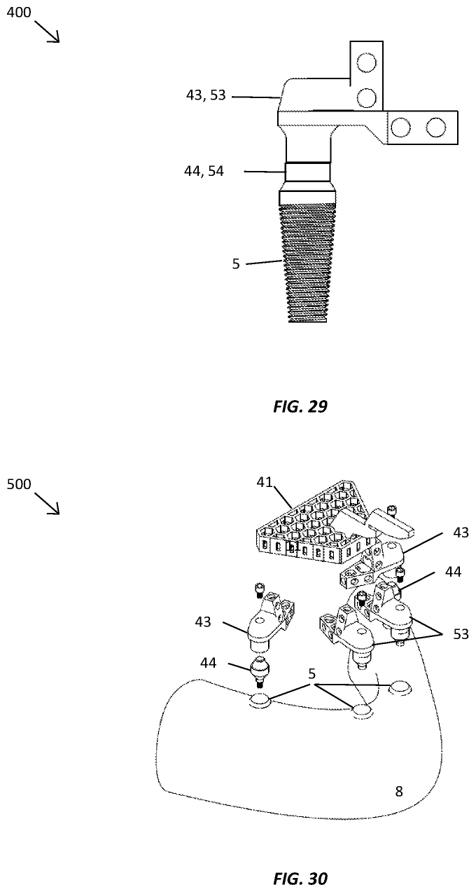

FIG. 29 shows a side view of either fastening component 43 or 53 fastened to implant 5.

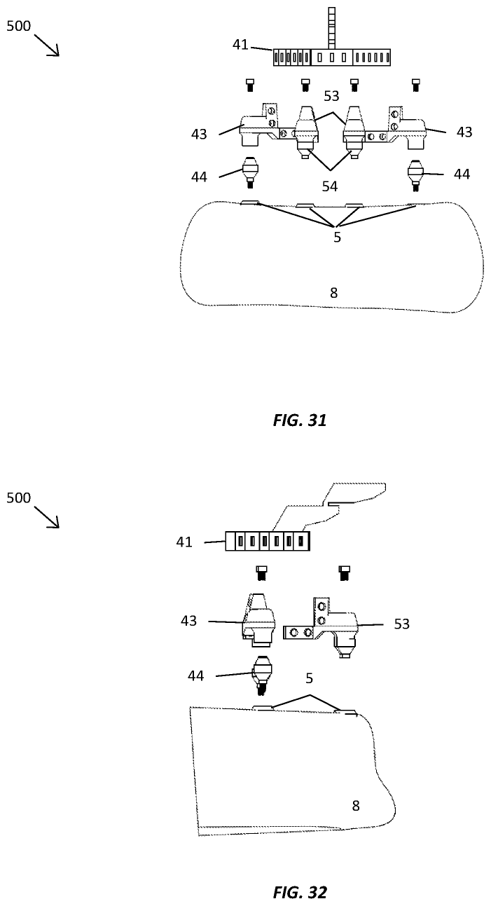

FIG. 30 shows a perspective exploded view of a dental device 500 and dental arch 8. Dental device 500 is similar to dental device 400 except that the two central fastening components 43 have been replaced with fastening components 53. FIG. 31 shows a front exploded view of dental device 500 and dental arch 8. FIG. 32 shows a side exploded view of dental device 500 and dental arch 8.

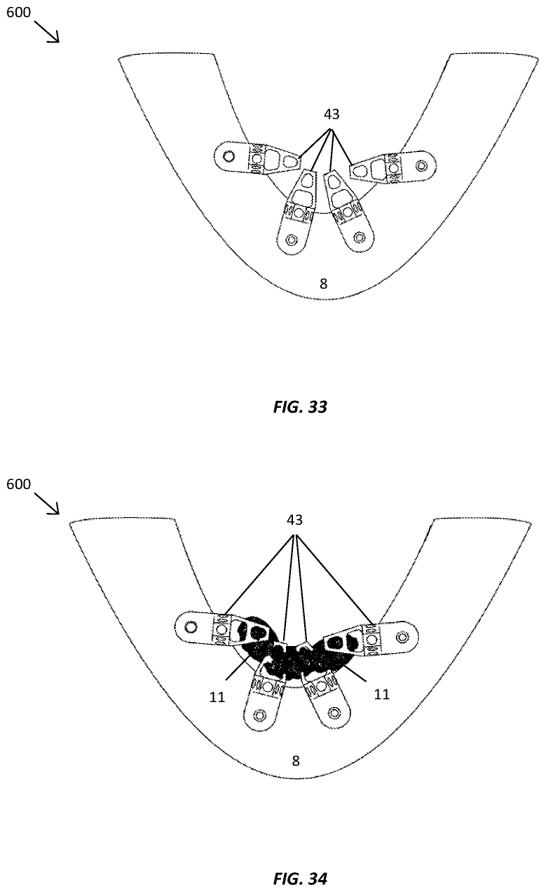

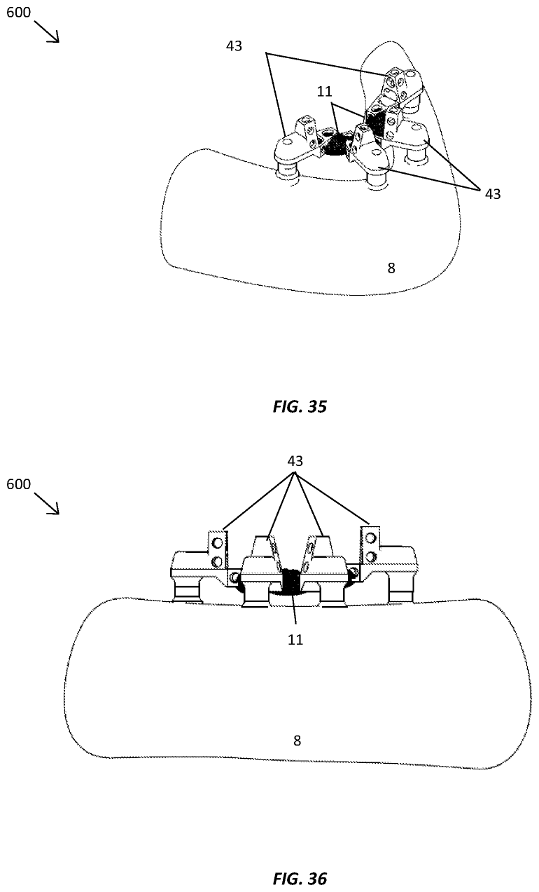

FIG. 33 shows a dental device 600 on dental arch 8. Dental device 600 comprises a plurality of fastening components 43. Fastening components 43 are similar to fastening components 3 and 23 except that they have a vertical structure 48 and different shaped wing regions 42. Each wing region 42 of the fastening components 43 is positioned to be in close proximity with adjacent wing regions 42. Once they are positioned in close proximity with adjacent wing regions 42, the wing regions 42 are joined together using an adhesive or luting material 11 as shown in FIGS. 34-36. Once joined together, fastening components 43 can be scanned with an intraoral camera to record their location, orientation, and angulation. Vertical structures 48 can help block luting material 11 from entering the holes in fastening components 43. Vertical structures 48 can also help improve the efficiency and/or accuracy of scanning methods by providing easily recognizable three-dimensional structures with known dimensions for algorithms to reference. Fastening components 43 can also be removed as a single unit and used as a verification jig. Dental device 600 is different than dental device 500 and 400 in that no frame member 41 is required.

From a methods perspective, the inventive subject matters includes a method of using a dental device having one or more fastening components and a frame member by (i) coupling the one or more fastening components to one or more dental attachments in a dental arch; (ii) positioning the wing region of the one or more fastening components by rotating them about the dental attachment; and (iii) bonding or luting the frame member to the one or more fastening components by applying an adhesive or hardening material to the attachment areas of the wing regions of the fastening components and the attachment areas of the frame member and waiting for them to cure together into one rigid apparatus.

In yet other aspects, the method can further comprise the step of removing the frame member and the one or more fastening components from the one or more dental attachments as a single apparatus and using the assembled apparatus as a verification jig that is used to verify the accuracy of a dental model that relates the exact physical position, rotation and angulation of the one or more dental attachments in the dental arch. The method can further comprise the steps of (i) selecting the one or more fastening components from a plurality of fastening components having various angles and different lengths of wing regions; and (ii) selecting the frame member from a plurality of frame members having different sizes so that the selected frame member fits with the dental arch and rests across all of the wing regions of the one or more fastening components.

In still other aspects, the method can comprise the step of applying common dental impression materials around the one or more fastening components to capture an impression of the gum tissue surrounding the one or more fastening components that relates the anatomy of the gum tissue to the position of the one or more dental attachments.

As used herein, and unless the context dictates otherwise, the term “attached to” “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the amended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification refers to at least one of something selected from the group consisting of A, B, C . . . and N, the text should be interpreted as requiring only one element from the group, not A plus N, or B plus N, etc.

What is claimed is:

1. A dental device comprising:
one or more fastening components each having a longitudinal axis and a wing region that extends radially outwardly from the longitudinal axis;
a frame member having a top surface and a bottom surface comprising one or more attachment areas;
wherein the longitudinal axis of the one or more fastening components is configured to mate with a dental attachment in a dental arch;
wherein the wing region of the one or more fastening components has a top surface, a bottom surface, and a vertical structure protruding from the top surface;
wherein the vertical structure has a front surface facing away from the longitudinal axis, a back surface facing towards the longitudinal axis, and one or more side surfaces extending parallel to the length of the wing region between the front surface and back surface; and
wherein the wing region has one or more attachment areas configured to couple with the one or more attachment areas disposed on the frame member.

2. The dental device of claim 1, wherein the one or more fastening components and the frame member are configured to minimize or eliminate dimensional fluctuation after the device is fabricated and throughout the life of its use.

3. The dental device of claim 1, wherein the frame member has a shape selected from the group consisting of trapezoidal, half-circle, triangular, square, and rectangular.

4. The dental device of claim 1, wherein the frame member is sized and dimensioned to fit with a dental arch.

5. The dental device of claim 1, wherein the frame member is scored in a way that would make it easy to size the frame to fit the dental arch.

6. The dental device of claim 1, wherein the attachment areas of the wing region of one or more fastening components have a plurality of teeth.

7. The dental device of claim 7, wherein the wing region of one or more fastening components are tapered.

8. The dental device of claim 1, wherein at least one of the attachment areas of the frame member and the wing region of one or more fastening components comprises a flat surface.

9. The dental device of claim 1, wherein at least one of the attachment areas of the frame member and the wing region of one or more fastening components have a plurality of undercuts or grooves.

10. The dental device of claim 1, wherein the attachment areas of the frame member and the wing region of the one or more fastening components have holes that extend from the top to the bottom of the frame member or the wing region of the fastening component.

11. The dental device of claim 1, wherein the one or more fastening components includes a first fastening component, a second fastening component, a third fastening component, a fourth fastening component, a fifth fastening component, and a sixth fastening component.

12. The dental device of claim 1, further comprising an adhesive for bonding the attachment areas of the frame member with the attachment areas of the wing region of the fastening component.

13. The dental device of claim 1, further comprising a hardening material for luting the attachment areas of the frame member with the attachment areas of the wing region of the fastening component.

14. A method of using the dental device of claim 1, comprising:
coupling the one or more fastening components to one or more dental attachments in the dental arch;
positioning the wing region of the one or more fastening components by rotating them about the dental attachment; and
bonding or luting the frame member to the one or more fastening components by applying an adhesive or hardening material to the attachment areas of the wing regions of the fastening components and the attachment areas of the frame member and waiting for them to cure together into one rigid apparatus.

15. The method of claim 14, further comprising the step of removing the frame member and the one or more fastening components from the one or more dental attachments as a single apparatus and using the assembled apparatus as a verification jig that is used to verify the accuracy of a dental model that relates the exact physical position, rotation and angulation of the one or more dental attachments in the dental arch.

16. The method of claim 14, further comprising the steps of:
selecting the one or more fastening components from a plurality of fastening components having various angles and different lengths of wing regions; and
selecting the frame member from a plurality of frame members having different sizes so that the selected frame member fits with the dental arch and rests across all of the wing regions of the one or more fastening components.

17. The method of claim 14, further comprising the step of applying common dental impression materials around the one or more fastening components to capture an impression of the gum tissue surrounding the one or more fastening components that relates the anatomy of the gum tissue to the position of the one or more dental attachments.

18. The dental device of claim 1, wherein the vertical structure is configured to shield an opening in the longitudinal axis of the one or more fastening components to prevent bonding or luting material from entering the opening.

19. A dental device comprising:
a plurality of fastening components each having a longitudinal axis and a wing region that extends radially outward from the longitudinal axis, wherein the longitudinal axis is configured to mate with a dental attachment in a dental arch;
a hardening material for luting the plurality of fastening components together when assembled in the dental arch; and
wherein the wing regions are sized and dimensioned to be in close proximity of one another when assembled in the dental arch to facilitate luting them together.

20. A method of using the dental device of claim 19, comprising:
coupling the plurality of fastening components to a plurality of dental attachments in the dental arch;
positioning the wing region of each fastening component by rotating it about the dental attachment until it is in close proximity with a wing region of at least one other fastening component;
bonding or luting the wing regions of the fastening components together by applying the hardening material to the surface of each wing region and between the wing regions of other fastening components; and
using a vertical structure protruding from a top surface of each wing region to prevent the hardening material from entering an opening disposed along the longitudinal axis of the fastening component.
